(19) United States
(12) Patent Application Publication
(10) Pub. No.: US 2024/0330772 A1
(43) Pub. Date: Oct. 3, 2024

(54) CALIBRATED MODEL INTERVENTION WITH CONFORMAL THRESHOLD

(71) Applicant: THE TORONTO-DOMINION BANK, TORONTO (CA)

(72) Inventors: Jesse Cole Cresswell, East York (CA); Noël Vouitsis, Markham (CA); Yi Sui, Newmarket (CA)

(21) Appl. No.: 18/618,757

(22) Filed: Mar. 27, 2024

Related U.S. Application Data
(60) Provisional application No. 63/456,694, filed on Apr. 3, 2023.

(51) Int. Cl. G06N 20/00

(52) U.S. Cl. CPC G06N 20/00

(57) ABSTRACT

A classification model is calibrated with a conformal threshold to determine a known error rate for classifications. Rather than directly use the model outputs, the classification model outputs are processed to a conformal score that is compared with a conformal threshold for determining whether a data sample is a member of a class. When a number of classes for the data sample that pass the conformal threshold for inclusion is a single class, an action associated with the class can confidently be applied with a known error rate. When the number of classes is zero or multiple classes, it may indicate sufficient uncertainty in the model prediction and the data sample may be escalated to another decision mechanism, such as manual review or a more complex classification model.

### CROSS REFERENCE TO RELATED APPLICATIONS

This application claims the benefit of U.S. Provisional Application No. 63/456,694, filed Apr. 3, 2023, the contents of which are hereby incorporated by reference in its entirety.

### BACKGROUND

This disclosure relates generally to computer modeling and more particularly to classification models used to automatically perform actions based on model classifications.

In general, classification models predict membership of a particular data instance with respect to a set of classes. In general, membership in the classes may also be associated with a particular action to be taken when an item is designated as a member of the class. For example, the classes may describe actions to perform for a user, such as whether to authorize a user to access a resource or to reject the resource access. Classification may also include object classification, categorization, and other types of classification tasks. Such classification models often output a score with respect to individual classes that may or may not be normalized (i.e., may or may not represent a “percent” prediction for each class) and typically are not calibrated across the classes. Often, the class with the highest raw output score for a class is considered the predicted class by the model.

In practice, model users must be careful with the interpretation of raw scores. Raw class prediction scores generally do not correspond to the probability that an input sample belongs to a particular class, unless they are properly calibrated. Generally, models trained by statistical routines, advanced analytics, or machine learning and artificial intelligence are not calibrated correctly by default. Usually, the calibration of the model must be checked using a calibration dataset not previously seen by the model; if calibration is unsatisfactory, raw score values can be corrected with a separate calibration model.

Even for a calibrated model, the raw scores of the model do not represent model uncertainty or the difficulty of classifying a data sample relative to other classes. For example, a binary classifier may indicate the same raw scores for one data sample that is similar to data seen during the training and for another data sample that is unlike any data seen during training, despite the significantly different certainty inherent in these predictions. Hence, even for a calibrated model, the uncertainty is not captured by the value of the raw scores output for particular classes.

These effects may make it difficult to effectively use model predictions with confidence or with a limitation on the potential error rates of the model predictions. As a result, it may also be difficult to effectively determine which predictions to evaluate with an escalated review process or manual review.

### SUMMARY

This disclosure relates to applying conformal scores to classification models to rigorously determine when model predictions of a class are sufficiently confident for automated action. When the model predictions are insufficiently confident, they are instead referred for additional analysis (e.g., a more complex model or human intervention). A classification model is trained to generate output scores for one or more output classes based on a training set. The output scores from the model generated from the training set may also be referred to as “raw” output scores for each class. Rather than directly use these output scores, the results from the model are processed to generate conformal scores associated with each class. The conformal scores may represent information about the class outputs relative to other class outputs, such that a lower conformal score (when calibrated) indicates a better correspondence between a class output (of the true data class) and the input. A set of calibration data may then be applied to the trained model to determine the conformal scores of the calibration data with respect to the output classes and calibrate a conformal threshold for determining class membership based on the conformal scores. The conformal threshold is calibrated with respect to an error rate for the output class(s) such that the conformal threshold ensures no more than the error rate of items designated for the class are improperly classified as the class. In various embodiments, different conformal thresholds may be determined for different output classes. The calibration of the conformal scores may then provide a statistical guarantee that designating an input as a member of a class does not exceed the error rate. For example, when the conformal score is below the conformal threshold (i.e., when a lower conformal score indicates a higher agreement for the class), the input may be designated as a member of that class.

When evaluating an input data sample, the conformal scores for each class are evaluated with respect to the threshold to determine whether the input data sample can be labeled with each of the respective classes in a class membership set for the input data sample. As such, the input sample may be labeled with zero, one, or more than one class. As designating membership with the conformal threshold provides a calibrated error rate for the class membership, when the input sample is designated with a single class, the input may be considered a member of that class and related actions may automatically be performed on the input based on the model prediction. However, when the class membership set includes multiple classes or no classes, this may indicate that there is significant uncertainty about the prediction for the input data sample, as the input data sample may have either failed to be sufficiently sure about any classes, or the model is “certain” (beyond the calibrated error rate) about multiple classes. As such, when the class membership set includes zero or multiple classes, the data sample may be escalated for additional resolution of the class membership. For example, in one embodiment, the data sample may be provided for manual review by a human evaluator or evaluation by a more complex computer model (e.g., that evaluates further input features or includes additional parameters and/or architectural layers than classification model). As such, the conformal scores and calibrated class membership provides statistical guarantees about the uncertainty of the model outputs and can enable automation of actions when the model is sufficiently “certain” and automatically escalate for further evaluation when the class membership does not sufficiently indicate one class for automated action.

### BRIEF DESCRIPTION OF THE DRAWINGS

FIG. 1 illustrates a computer modeling system for training and applying a classification model, according to one or more embodiments.

FIG. 2. illustrates an overview of conformal scores and a conformal threshold used for class membership prediction, according to one or more embodiments.

FIGS. 3 and 4 show example processes for a training classification model and a conformal threshold, according to one or more embodiments.

FIGS. 5 and 6 show example charts applying class membership sets to example data sets, according to one or more embodiments.

FIG. 7 shows a process for using conformal scores with a classification model, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Architecture Overview

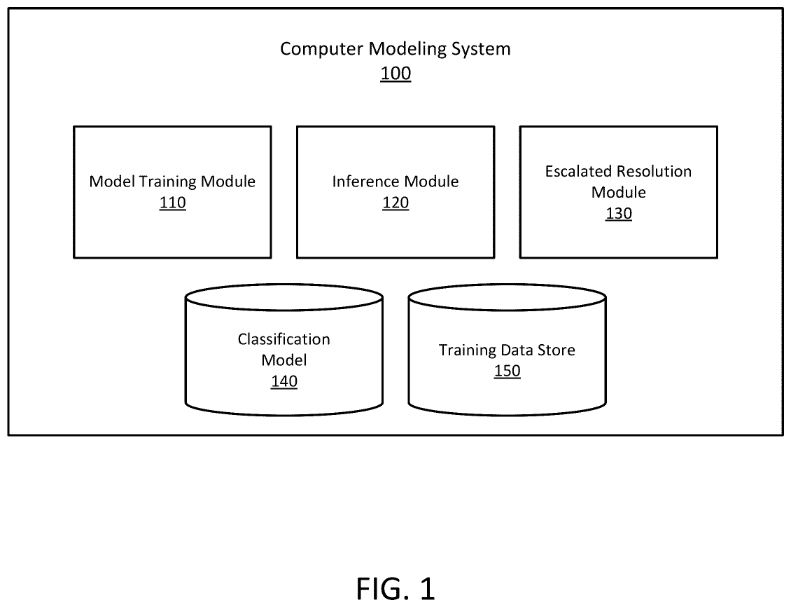

FIG. 1 illustrates a computer modeling system 100 for training and applying a classification model 140, according to one or more embodiments. The classification model 140 may be any type of computer-trained model with parameters learned through a training process that evaluates membership of an input (also termed an input data sample or data instance) with respect to two or more classes. The computer modeling system 100 includes a set of computing modules for training and applying the classification model 140, along with a training data store 150 including a set of training data for training the parameters of the classification model 140. Alternative embodiments may include more, fewer, or different components from those illustrated in FIG. 1, and the functionality of each component may be divided between the components differently from the description below.

Additionally, the computer modeling system 100 may also communicate with one or more other systems to exchange information, which are not shown in FIG. 1 for convenience. The computer modeling system 100 may communicate with other systems and various user devices, for example, to receive training or other data, to receive input samples for inference analyses, to receive inputs from a user of the computer modeling system 100, to transmit results of inference analyses, and so forth.

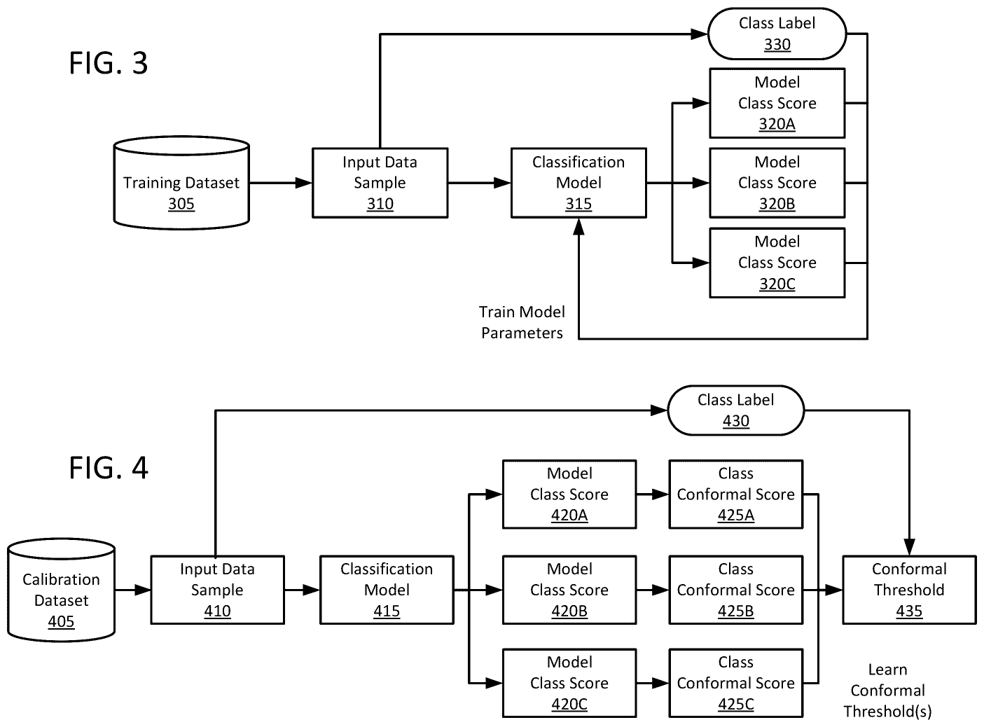

The computer modeling system 100 may use a classification model 140 to automatically predict a class for a received data sample and apply a related action. The classification model 140 is a machine-learning model that is trained to generate output scores (“raw scores”) for each class of a plurality of classes. The classification model 140 may use, in various embodiments, heuristics, statistics, advanced analytics, machine learning, artificial intelligence, or other methods for generating output scores. As further described in conjunction with FIGS. 3 and 4, the classification model 140 may be trained with labeled data samples in a training data set, e.g., data samples stored by the training data store 150.

Once trained, the classification model 140 may be used in one or more applications for authorization and access to systems, risk analysis (e.g., system intrusion), financial and/or credit risk analysis, medical risk analysis (mortality or long-term health diagnoses), image processing classification, or the like. In other embodiments, the classification model 140 may be used in any other suitable application in which risk or uncertainty may be quantified.

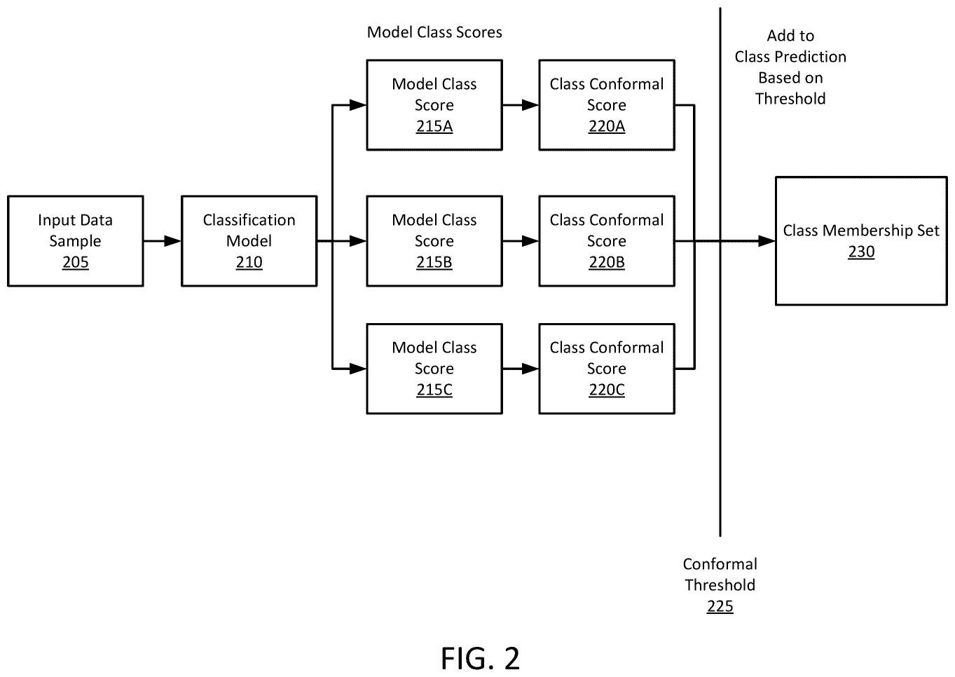

Specifically, and as discussed further in conjunction with FIG. 2, when the classification model 140 receives input data, the classification model generates output scores for each class. Rather than directly use the output scores from the model, the output scores are evaluated to determine conformal scores for each class. Conformal scores describe agreement of the output scores for the various classes. The conformal scores are then evaluated with respect to a calibrated conformal threshold to indicate membership in the class (e.g., as a Boolean). Using the conformal scores and the conformal threshold, the class membership may have a known confidence level/error rate of class membership designations.

In some embodiments, the classification model 140 is trained with a model training module 110 using training data samples stored in training data store 150. Generally, the training data includes training data samples used to train parameters of the classification model 140 (for generating class output scores) and additionally includes data samples used to calibrate the conformal thresholds. The training data store 150 thus may include two separate data sets: training data and calibration data. Training of the classification model 140 and calibration thresholds are discussed more with respect to FIGS. 3 and 4.

An inference module 120 receives new data samples for classification and evaluates the received data samples with respect to the classification model 140. Based on the output conformal scores by the classification model 140, the inference module 120 identifies a class membership set comprising one or more classes predicted by the classification model for the data samples. The number of classes in the class membership set (i.e., classes with conformal scores that pass the conformal threshold) may then be used to characterize the confidence of the model and whether the model class prediction should be used or the data sample should be further evaluated. The inference module 120 evaluates whether a single class is predicted, in which case the model may be confident about that single class. If no class is predicted or multiple classes are predicted, this indicates uncertainty in the overall prediction, as either no class passed the predictive threshold and results in an empty class membership set, or that multiple classes passed the predictive threshold and results in a class membership set consisting of multiple classes. As such, when no class is predicted or multiple classes are predicted, the inference module 120 may provide the data sample to an escalated resolution module 130 for review.

When a single class is predicted by the class membership set (e.g., the class membership set consists of one class), the inference module 120 may automatically take one or more actions associated with the predicted class. The specific action may vary according to the different classes and the application of the computer modeling system 100. For example, the inference module 120 may transmit notifications to users of the computer modeling system 100 based at least in part on a class associated with the user and/or user data, may enable permissions for users of the computer modeling system to access information or further actions, may associate the class with the data sample, and so forth. When the inference module 120 applies the classification model 140 and the resulting set of classes is not a single class, the data sample may be provided to the escalated resolution module 130 for determining a class for the data sample.

The escalated resolution module 130 evaluates and resolves class membership for uncertain cases (i.e., when the class membership includes no classes or more than one class). That is, the escalated resolution module 130 may provide an alternative way for determining class membership that may be used when the classification model 140 is uncertain. As such, applying the classification model 140 may typically use lower computational resources or other requirements relative to the process used by the escalated resolution module 130. When the classification model 140 is relatively certain about a class, the corresponding action may thus be automatically applied, such that the higher resource use or other investment of the escalated resolution module 130 are applied only to more difficult/“uncertain” data instances. As previously noted, uncertain cases may occur when the inference module 120 finds that no classes are predicted for an input data sample or that multiple classes are predicted for an input data sample.

As one example, the escalated resolution module 130 may comprise applying a more sophisticated computer model to the data sample. The more sophisticated computer model may include more complex input features and/or model architecture (e.g., more parameters). As such, the classification model 140 may represent a “first line” classification that, when sufficiently confident, can be automatically applied, and “difficult”/uncertain cases may be automatically identified with statistical rigor and escalated for more sophisticated evaluation.

As another example, the escalated resolution module 130 may provide an interface for manual review by a user of the computer modeling system 100. For example, the escalated resolution module 130 may transmit information about the data sample to a user of the computer modeling system 100 to manually identify a correct class for the data sample. In some embodiments, the escalated resolution module 130 may additionally transmit the class output scores, the conformal scores, or other model information, alongside the data sample for human evaluation of the data sample and selection of a relevant class and associated action.

The escalated resolution module 130 may then identify (e.g., via an additional model, manual review, or other means) a selected class that may be returned to the inference module 120 for application of one or more actions associated with the selected class.

In some embodiments, the inference module 120 and/or the escalated resolution module 130 may additionally or instead transmit a determined class for a data sample to another system or module not shown here, which may perform one or more actions responsive to the determined class.

FIG. 2. illustrates an overview of conformal scores and a conformal threshold used for class membership prediction, according to one or more embodiments. FIG. 2 shows an example class membership set 230 determined for a particular input data sample 205. Rather than determine a specific “most-likely” class for the data sample, the class membership set 230 describes a set of classes that the data sample 205 may be associated with, and may include the null set. Thus, the class membership set 230 may identify a number of classes that the input data sample 205 is predicted to belong in based on a trained classification model 210 and the conformal threshold 225. For two classes x and y (e.g., a binary classifier), for example, the class membership set may thus designate { } (the null set), {x}, {y}, or {x,y}. The output class membership set 230 thus receives heuristic notions of uncertainty, like the output scores from the trained classification model 210 and converts them into a statistically rigorous notion of uncertainty in the form of a membership set. Thus, rather than outputting a single class (e.g. either 0 or 1 in binary classification), the set of predictions provides a statistical guarantee that the true label is in the output class membership set 230 with a probability of at least 1−α, where α is an error rate. The number of classes in the output set for a particular input data sample 205 thus quantifies the uncertainty that the model has about the input data sample 205, such that larger sets (i.e., more classes) imply additional uncertainty about the true class membership of the input data sample 205.

To generate the class membership set 230, features of the input data sample 205 are input to the classification model 210 to generate output class scores for each class. In the example of FIG. 2, the classification model 210 is trained to generate model class scores 215A-C, representing outputs of the model related to each of three classes. The model class scores 215A-C may represent “raw” scores related to each class and may not be normalized or otherwise relate to the relative strength of a class prediction relative to others. For example, each of the model class scores 215A-C may be an output of respective prediction heads for the classification model 210. In other examples, the model class scores 215A-C are normalized, for example after application of a softmax function or other normalization layer to the class predictions.

The model class scores 215A-C are then evaluated to generate a respective set of class conformal scores 220A-C. The conformal scores 220A-C generally describe the relative certainty of the respective classes and may be determined in various ways. In general, a conformal score function s generates a class conformal score 220 based on one or more of the model class scores 215, where larger conformal scores indicate worse agreement between an input data sample and a predicted class. The conformal score function may vary in different embodiments. In one embodiment, the conformal score function sₖ for a given class k is one minus the model class score 215: (sₖ=1−yₖ) where yₖ is the classification model output (the model class score 215) for class k.

In another embodiment, the conformal score function s accumulates the model class scores that are higher than the subject class score. In this embodiment, the model class scores 215 are ordered from largest to smallest, such that the class conformal score 220 is the accumulated value of the model class scores until the index of the class k. The score function thus accumulates the model class scores (in descending order) until the index of the subject class. The conformal score in this embodiment may be given by:

$${s}_{k} = {\sum }_{j = 0}^{k} {π}_{j}$$

where π is the permutation of model class scores 215 indexed in descending order (i.e., from largest model class score to smallest) with the index πₖ for class k.

The class conformal scores 220A-C are then compared with a conformal threshold 225 to determine classes that pass the conformal threshold 225. The value of each class conformal score 220 is compared with the conformal threshold 225 and each class having a class conformal score 220 below the conformal threshold 225 (when lower conformal scores represent higher agreement/certainty) is added to the class membership set 230. During calibration of the conformal threshold 225, the conformal threshold 225 is set at a level based on an error rate, such that the class membership set is expected to have at least the true class at a rate based on the error rate used in calibration. As a result, the “true” class has a statistically guaranteed error rate with respect to membership in the class membership set 230 (provided the tested data item is drawn from the same distribution as the calibration data set). When the class membership set 230 includes more than one class or a null set, this may also represent relative uncertainty by the model, such that a tested data instance may be escalated for further determination of a relevant class.

As such, conformal scores for each class may then be evaluated with respect to a conformal threshold to determine the class membership set. In embodiments discussed above, low conformal scores indicate higher confidence of class membership. Where low conformal scores represents higher output scores for a class and “agreement” across classes, classes with conformal scores below the conformal threshold are added to class membership set. When the model is trained on appropriate data and the conformal scores are calibrated effectively for a data set that is similar to new data samples, a single class qualifying for the class membership set may thus indicate high confidence (with a statistical guarantee defined by the error rate) of the data sample belonging to the indicated class. When the class membership set is null or includes multiple classes, either no classes or multiple classes satisfy the calibrated conformal threshold, indicating insufficient confidence about any particular class.

FIGS. 3 and 4 show example processes for training a classification model and a conformal threshold, according to one embodiment. As discussed above, the overall data set used to learn parameters for the classification model and the conformal threshold may include two data sets-a training dataset 305 for training parameters of the classification model and a calibration dataset 405 for calibrating a conformal threshold 435.

Training of the classification model 315 may use any suitable computer model training process consistent with the architecture of the classification model 315. Each data instance in the training dataset 305 may be selected as an input data sample 310 and processed by parameters of the classification model 315 to generate scores for each of the classes as model class scores 320A-C. The model class scores 320A-C are then compared with a class label 330 based on a loss function to train model parameters that minimize the loss function relative to the class label 330. The loss function may be any suitable loss function for classification, such as cross-entropy/log loss and hinge loss functions. The classification model is trained with any suitable training mechanism, and may include applying one or more batches of the training dataset 305 that may generate gradients that are backpropagated through layers of the classification model 315. Although one training approach is shown in FIG. 3, any suitable classification model 315 architecture and training process may be used to generate a classification model 315 that generates model class scores 320A-C.

A calibration dataset 405 may then be used as shown in FIG. 4 to determine a conformal threshold 435 that may be applied as shown in FIG. 2. Although one conformal threshold is shown in FIG. 4, in further embodiments, a distinct conformal threshold 435 may be determined for each class, such that membership of a data sample in the class is determined based on the conformal threshold associated with that class.

During training of the conformal threshold 435, the data samples of the calibration dataset 105 are processed to generate the relevant model class scores 420A-C and conformal scores 425A-C as discussed above using the classification model 415. That is, after training of the classification model, an input data sample 410 may be processed by the classification model 415 using the trained parameters to determine the predicted values for each class as represented in the model class scores 420A-C. Similarly, the class conformal scores 425A-C may be generated with respect to each class. In some embodiments, the conformal score only for a class label 430 of the input data sample 410 is generated. The class label 430 represents the “true” class for the input data sample 410 and is used to learn the conformal threshold 435 that calibrates the conformal threshold with respect to an error rate a.

To set the conformal threshold 435, the conformal threshold may be a quintile of the conformal scores based on the error rate. In one embodiment, the conformal threshold is chosen based on a calibration dataset, such that \hat{q} is the |(n+1)(1−α)|/n quantile of the conformal scores with respect to the true class (the class label 430) of the input data sample 410 in the calibration dataset 405 of size n. That is, the conformal threshold 435 is set, such that the probability of the true class being in the prediction set is close to 1 minus the error rate, with the closeness scaling according to the size n of the calibration dataset. In some embodiments, the error rates may differ for each class, such that the conformal threshold is determined based on an error rate for each class, and the quintile of conformal scores (to determine the conformal threshold) is determined with respect to scores for each class.

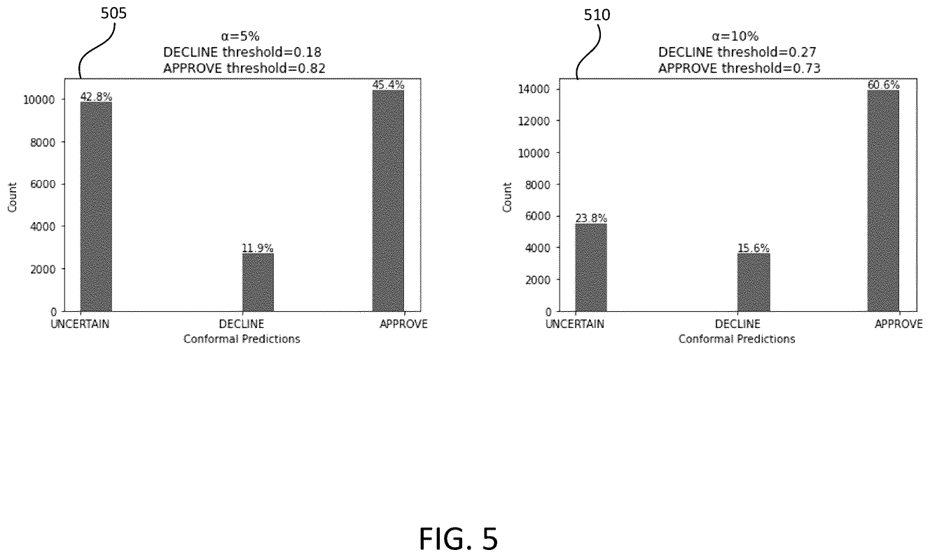

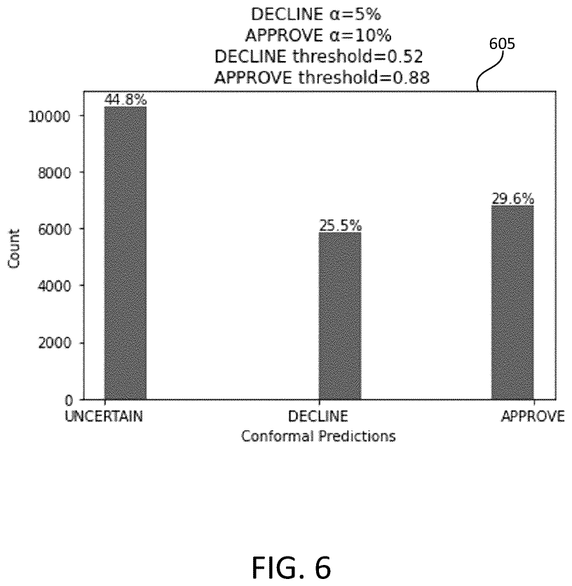

FIGS. 5 and 6 show example charts applying class membership sets to example data sets, according to one or more embodiments. In these examples, the classification model is a binary classifier in which one class is “approve” and another class is “decline” related to automatic decisions for loan origination. These examples show the results of test data samples applied to the trained classification model and conformal thresholds as shown in FIG. 2 to determine a membership set for each data sample. In this experiment, the conformal score was determined as 1 minus the class prediction and an XGBOOST classifier was trained for class predictions.

In this example, the dataset was a decision whether to extend financial credit for mortgage and home equity line of credit for pre-approval applications. The classification model predicted underwriter decisions on submitted applications and was trained and calibrated with data collected from August 2017 to October 2021. Data from November 2021 to October 2022 was used as test data to analyze the classification of unseen applications.

When the data sample yields a single class (“DECLINE” or “APPROVE”), the data sample is indicated in the appropriate column. When the class membership includes multiple or zero classes, however, indicating that either multiple classes or no classes passed the conformal threshold for class membership inclusion, the data sample is designated “uncertain” and as discussed above may be escalated for further evaluation, e.g., by a more complex computer model or by a human evaluator.

In a first chart 505, the error rate is set to 5% (shown as α), which results in a conformal threshold of 0.18 for a “decline” decision and a conformal threshold of 0.82 for an “approve” decision. Similarly, in a second chart 510, the error rate is set to 10%, which results in a conformal threshold of 0.27 for a “decline’ decision and a conformal threshold of 0.73 for an “approve” decision. When applied to a testing dataset, these examples show that the model learns to automatically and confidently predict “decline” and “approve” decisions in a majority of data samples with calibrated error rates of 5% and 10%. The “uncertain” data samples indicate the situations in which the class membership was not a single class (i.e., the class membership was null or included both approve and decline).

As shown in FIG. 5, more conservative error tolerances require the model to be more confident to approve or decline applications, yielding more “uncertain” predictions. In fact, in graph 505, when the error rate is 0.05 (with corresponding correctness of 95%), the classification model can confidently determine a class on 57% of the test data set and will engage further evaluation on the remaining 43%. Conversely, if the error rate is less conservative and requires a probability of correctness of at least 90% (i.e., α=0.1), this approach will now return an immediate decision on 76% of application submissions and will only engage human judgement on the remaining 24%. This demonstrates a clear benefit in enabling adjustment of automatic classification based on risk tolerance and automatic use of model classification in many cases while referring appropriate cases for further review (e.g., human-in-the-loop decisioning). This approach still largely benefits from the decisions made by the classification model while providing guarantees of correctness and error rates.

FIG. 6 shows an example of class-conditional error rates for the experimental data set used in FIG. 5. In this example, the training data may be used to train the model for classification, and calibration may set different error rates for the respective conformal thresholds for the different classes. In this example, calibration is thus performed separately for approved and declined applications in the calibration set. In this experiment, the error rate for “decline” decisions s set to 0.05 and the error rate for “approve” decisions s set to 0.10. As shown in graph 605, the resulting thresholds change the frequency that single classes are selected, decreasing the frequency of single-class approve and increasing the frequency of single-class declines.

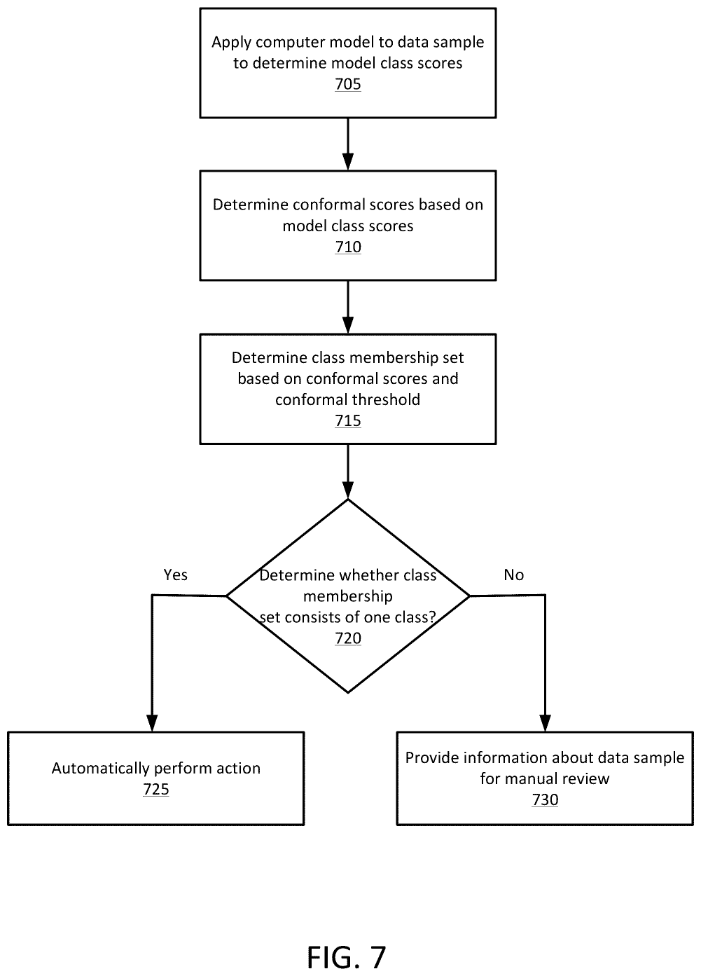

FIG. 7 shows a process for using conformal scores with a classification model, according to one embodiment. This process may be performed, for example, by an inference module 120 of a computer modeling system 100 with a classification model 140 trained on a set of training data and having a calibrated conformal threshold as discussed above.

Initially, the process identifies a data sample for classification and applies 705 the computer model (e.g., the classification model 140) to determine model class scores describing the model prediction for the possible classes. Next, the model output scores are used to determine 710 conformal scores for each class as discussed above, e.g., with respect to FIGS. 2-4. The conformal scores are compared with the conformal threshold to determine 715 a class membership set that includes the classes having a conformal score meeting the conformal threshold (e.g., having a conformal score below the threshold).

The class membership set may then be used to evaluate uncertainty of the classification model, such that the class is “certain” about class membership (with an error rate calibrated by the conformal threshold) when the class membership set includes one class. Hence, the process may determine 720 whether the class membership set consists of one class, which indicates relative certainty of the model's classification for that class. When the class membership set has a single class, the process may then automatically perform 725 an associated action related to the class.

When the class membership set does not have a single class (which may include no classes or multiple plurality of classes), the classification model can be deemed insufficiently certain (below the calibrated conformal threshold) about any specific class. As such, the data sample may be escalated for further evaluation, for example by another computer model or, in some instances, to a human reviewer. In the example of FIG. 7, the data sample is provided 730 for review by a human expert to determine a classification. The human reviewer may also be provided information about the model inputs and/or outputs, such as the class output scores, conformal scores, and/or other information about the model processing, such as shapley values describing the relative effect of various input features on the model class outputs.

As a result, the classification model may, with a known error rate, be used to effectively handle many cases and “triage” cases that may readily be processed by the classification model with sufficient confidence. This may reduce computing power relative to sending all data samples to be tested through a more complex model and provide an effective alterative that reduces computing load on more complex or intensive classification processes.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A system for selective model intervention, comprising:
a processor configured to execute instructions; and
a computer-readable medium having instructions executable by the processor for:
applying a computer model to a data sample to determine a plurality of model class scores corresponding to a plurality of class outputs of a plurality of classes;
determining a plurality of conformal scores corresponding to the plurality of class outputs based on the plurality of model class scores;
determining a class membership set based on the plurality of conformal scores and a conformal threshold;
determining whether the class membership set consists of one class of the plurality of class outputs;
automatically performing an action when the class membership set is determined to consist of one class of the plurality of class outputs; and
when the class membership set is determined not to consist of one class, providing information about the data sample for manual review.

2. The system of claim 1, wherein the information provided about the data sample for manual review includes the plurality of model class scores.

3. The system of claim 1, wherein a conformal score for a class of the plurality of conformal scores is determined by accumulating the model class scores in a decreasing ranking of the plurality of conformal scores until an index of the class in the decreasing ranking.

4. The system of claim 1, wherein each class has an associated conformal threshold for determining membership of that class in the class membership set.

5. The system of claim 1, wherein the conformal threshold is based on an error rate.

6. The system of claim 1, wherein the instructions are further executable for:
training the computer model with a training set; and
determining the conformal threshold based on a calibration dataset and an error rate.

7. The system of claim 6, wherein the instructions are further executable for determining a plurality of conformal thresholds based on a plurality of error rates associated with the plurality of classes.

8. A method for selective model intervention, comprising:
applying a computer model to a data sample to determine a plurality of model class scores corresponding to a plurality of class outputs of a plurality of classes;
determining a plurality of conformal scores corresponding to the plurality of class outputs based on the plurality of model class scores;
determining a class membership set based on the plurality of conformal scores and a conformal threshold;
determining whether the class membership set consists of one class of the plurality of class outputs;
automatically performing an action when the class membership set is determined to consist of one class of the plurality of class outputs; and
when the class membership set is determined not to consist of one class, providing information about the data sample for manual review.

9. The method of claim 8, wherein the information provided about the data sample for manual review includes the plurality of model class scores.

10. The method of claim 8, wherein a conformal score for a class of the plurality of conformal scores is determined by accumulating the model class scores in a decreasing ranking of the plurality of conformal scores until an index of the class of the class in the decreasing ranking.

11. The method of claim 8, wherein each class has an associated conformal threshold for determining membership of that class in the class membership set.

12. The method of claim 8, wherein the conformal threshold is based on an error rate.

13. The method of claim 8, further comprising:
training the computer model with a training set; and
determining the conformal threshold based on a calibration dataset and an error rate.

14. The method of claim 13, further comprising determining a plurality of conformal thresholds based on a plurality of error rates with the plurality of classes.

15. A non-transitory computer-readable medium for selective model intervention, the non-transitory computer-readable medium comprising instructions that, when executed by a processor, cause the processor to:
apply a computer model to a data sample to determine a plurality of model class scores corresponding to a plurality of class outputs of a plurality of classes;
determine a plurality of conformal scores corresponding to the plurality of class outputs based on the plurality of model class scores;
determine a class membership set based on the plurality of conformal scores and a conformal threshold;
determine whether the class membership set consists of one class of the plurality of class outputs;
automatically perform an action when the class membership set is determined to consist of one class of the plurality of class outputs; and
when the class membership set is determined not to consist of one class, provide information about the data sample for manual review.

16. The non-transitory computer-readable medium of claim 15, wherein the information provided about the data sample for manual review includes the plurality of model class scores.

17. The non-transitory computer-readable medium of claim 15, wherein a conformal score for a class of the plurality of conformal scores is determined by accumulating the model class scores in a decreasing ranking of the plurality of conformal scores until an index of the class of the class in the decreasing ranking.

18. The non-transitory computer-readable medium of claim 15, wherein each class has an associated conformal threshold for determining membership of that class in the class membership set.

19. The non-transitory computer-readable medium of claim 15, wherein the conformal threshold is based on an error rate.

20. The non-transitory computer-readable medium of claim 15, wherein the instructions are further executable to:
train the computer model with a training set; and
determine the conformal threshold based on a calibration dataset and an error rate.
